(19) United States
(12) Patent Application Publication
(10) Pub. No.: US 2008/0248274 A1
(43) Pub. Date: Oct. 9, 2008

(54) High Damping, High Stiffness Multilayer Metal Polymer Sandwich Structure and Method

(75) Inventor: Karl-Heinz Hierholz, Stuttgart (DE)

Correspondence Address: QUINN LAW GROUP, PLLC, 39555 ORCHARD HILL PLACE, SUITE # 520, NOVI, MI, 48375, US

(73) Assignee: Material Sciences Corporation, Elk Grove Village, IL (US)

(21) Appl. No.: 11/697,400

(22) Filed: Apr. 6, 2007

(51) Int. Cl. B32B 9/04; B32B 15/04; B32B 27/06

(52) U.S. Cl. 428/220; 29/428; 428/411.1; 428/457

(57) ABSTRACT

An improved multilayer laminate is provided that provides increased flexural stiffness and increased damping. The laminate includes a thick and stiff lightweight core layer; a first and second constraining layer flanking the core layer; a first damping layer in contact with one of the first and the second constraining layers and spanning substantially the entirety of the respective first or second constraining layer with which it is in contact; and wherein the stiff core layer has a thickness at least approximately 10 times the first damping layer. The stiff core layer has a thickness at least approximately 20% of the multilayer laminate. The laminate may include a second damping layer in contact with the other of the first and the second constraining layers. The shear modulus of the stiff core layer is at least approximately a factor of 10 higher than the shear modulus of the first damping layer.

### TECHNICAL FIELD

The present invention relates to an improved multilayer laminate or sandwich structure that provides increased structural stiffness and increased damping by being built up as a geometrical stack-up of at least four layers.

### BACKGROUND OF THE INVENTION

Attaching a layer of viscoelastic material to component parts of a mechanical system for reducing unwanted vibrations is well known throughout the mechanical arts. The ability of the damping structure to damp vibrations is known as its “loss factor”, with a higher loss factor indicating greater damping capability. Current products provide damping by introducing a thin layer of viscoelastic material between two thicker layers of metal. The reduced shear stiffness of the viscoelastic material compared to metal allows for higher shear strains and therefore higher dissipation of energy. However this results in a reduction of flexural stiffness.

### SUMMARY OF THE INVENTION

The present invention provides both increased flexural stiffness and increased damping by being built up as a geometrical stack-up of at least four layers; two relatively thin outer metal layers, one thick and stiff lightweight core layer and at least one layer of thin viscoelastic or rubber damping material between one or both of the outer metal layers and the thick stiff core layer. “Flexural” refers in general to bending deformations and bending modes.

An improved multilayer laminate or sandwich structure of increased structural stiffness and damping is provided, including a thick and stiff core layer; a first and second constraining layer flanking the stiff core layer; a first damping layer in contact with one of the first and the second constraining layers and spanning substantially the entirety of the first and second constraining layers; and wherein the stiff core layer has a thickness of at least approximately 10 times the first damping layer.

In one aspect of the invention, the stiff core layer has a thickness of at least approximately 20% of the multilayer laminate. In another aspect of the invention, the stiff core layer has a thickness of at least approximately 50% of the multilayer laminate.

In another aspect of the invention, the stiff core layer includes a material having a relatively high stiffness with respect to the first damping layer. In another aspect of the invention, the shear modulus of the stiff core layer is at least approximately a factor of 10 higher than the shear modulus of the first damping layer.

In another aspect of the invention, the stiff core layer is comprised of a polymer material. In another aspect of the invention, the first and second constraining layers are metal; and the first and second constraining layers each have a thickness of at least approximately 0.25 mm. In another aspect of the invention, the stiff core layer is polypropylene, with the stiff core layer having a thickness of at least approximately 0.8 mm and the first damping layer has a thickness of at least approximately 0.025 mm. In another aspect of the invention, the first damping layer has a thickness of at least 0.012 mm.

In another aspect of the invention, the first damping layer comprises a first viscoelastic material. In another aspect of the invention, the improved multilayer laminate further includes a second damping layer in contact with the other of the first and the second constraining layers.

In another aspect of the invention, the stiff core layer comprises a material having a relatively high stiffness with respect to the second damping layer and wherein the stiff core layer has a thickness at least approximately 10 times the second damping layer. In another aspect of the invention, the first and second damping layers have a substantially equal thickness.

In another aspect of the invention, the shear modulus of the stiff core layer is at least approximately a factor of 10 higher than the shear modulus of the second damping layer.

In another aspect of the invention, the first damping layer comprises a first viscoelastic material, and the second damping layer comprises a second viscoelastic material. In another aspect of the invention, the first viscoelastic material and the second viscoelastic material have differing temperature ranges for optimal damping.

Variations in the stiffness and damping properties of the improved multilayer laminate can be made by varying the type and thickness of the first and second constraining layers with metals such as steel, aluminum, magnesium or other metals or alloys and by varying the material and thickness of the stiff core layer and first and second damping layers.

A high-stiffness vibration damping structure is provided including: a stiff core layer that has a thickness of at least 20% of the structure and spans substantially the entirety of the structure; a first and second constraining layer flanking the core layer; a first damping layer adjacent one of the first and the second constraining layers; wherein the stiff core layer has a thickness at least 10 times the first damping layer; and wherein the shear modulus of the stiff core layer is at least a factor of 10 higher than the first damping layer.

In another aspect of the invention, the damping structure includes a stiff core comprised of polypropylene; wherein the first and second constraining layers are metal; wherein the first and second constraining layers each have a thickness of at least 0.25 mm; wherein the stiff core layer has a thickness of at least 0.8 mm; and wherein the first damping layer has a thickness of at least 0.012 mm. In another aspect of the invention, the damping structure includes a first damping layer with a thickness of at least 0.025 mm. In another aspect of the invention, the damping structure further includes a second damping layer in contact with the other of the first and the second constraining layers.

A method is provided to increase the structural stiffness and damping of a multilayer laminate having first and second constraining layers including: configuring the first and second constraining layers as a spaced pair of relatively thin outer metal sheets; positioning one relatively thick and lightweight stiff core between the pair of relatively thin outer metal sheets and coextensive therewith; and positioning a layer of relatively thin viscoelastic material between one or both of the outer metal sheets and the stiff core and coextensive respectively with one or both of the outer metal sheets.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional view of an improved multilayer laminate or sandwich structure according to the present invention;

FIG. 2 is a graph of a numerical simulation showing dynamic stiffness characterized by bending eigenfrequencies in Hz at bending modes 2 through 5 for configurations A-F as described below, with a stiff core layer thickness of 0.8 mm for configurations C-F, with the theoretical simulation for FIGS. 2-10 being based on the ASTM E756 Oberst beam measurement;

FIG. 3 is a graph of a numerical simulation showing dynamic stiffness characterized by bending eigenfrequencies relative to iso-weight monolithic steel at bending modes 2 through 5 for configurations A-F, with a stiff core layer thickness of 0.8 mm for configurations C-F;

FIG. 4 is a graph of a numerical simulation showing composite loss factors at bending modes 2 through 5 for configurations A-F, with a stiff core layer thickness of 0.8 mm for configurations C-F;

FIG. 5 is a graph of a numerical simulation showing dynamic stiffness characterized by bending eigenfrequencies in Hz at bending modes 2 through 5 for configurations A-F, with a stiff core layer thickness of 2.0 mm for configurations C-F;

FIG. 6 is a graph of a numerical simulation showing dynamic stiffness characterized by bending eigenfrequencies relative to iso-weight monolithic steel at bending modes 2 through 5 for configurations A-F, with a stiff core layer thickness of 2.0 mm for configurations C-F;

FIG. 7 is a graph of a numerical simulation showing composite loss factors at bending modes 2 through 5 for configurations A-F, with a stiff core layer thickness of 2.0 mm for configurations C-F;

FIG. 8 is a graph of a numerical simulation showing bending eigenfrequencies relative to iso-weight monolithic steel at bending mode 3 for configurations A and C-F with varying stiff core thicknesses;

FIG. 9 is a graph of a numerical simulation showing bending eigenfrequencies relative to iso-weight monolithic steel at bending mode 3 for different ratios of the stiff core layer shear modulus to the viscoelastic damping layer shear modulus and stiff core thicknesses of 0.8 mm and 2.0 mm; and

FIG. 10 is a graph of a numerical simulation showing composite loss factors relative to iso-weight monolithic steel at bending mode 3 for different ratios of the stiff core layer shear modulus to the viscoelastic damping layer shear modulus and stiff core thicknesses of 0.8 mm and 2.0 mm.

### DESCRIPTION OF THE PREFERRED EMBODIMENTS

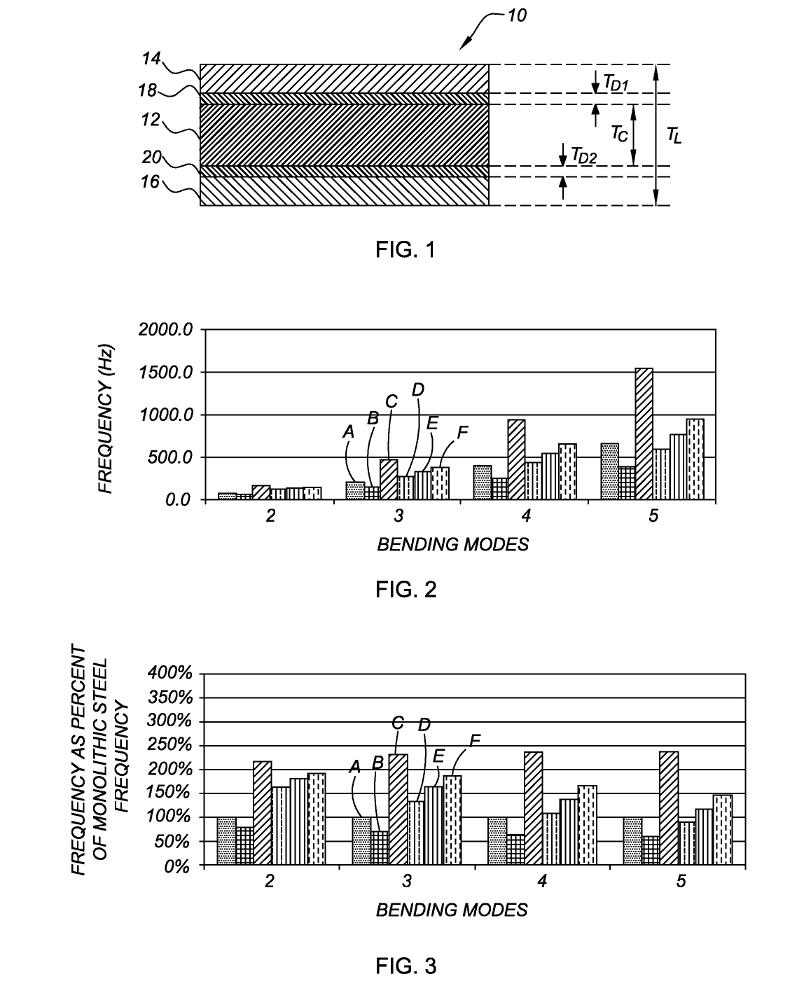

Referring to the drawings, FIG. 1 illustrates a schematic cross-sectional view of an improved multilayer laminate or sandwich structure 10 in accordance with the present invention. The laminate 10 includes a relatively thick and stiff lightweight core layer 12 that has a thickness of at least approximately 20% of the thickness of the laminate 10 and spans substantially the entirety of the laminate 10. Thus if the laminate 10 has a thickness T_{L}, the stiff core layer 12 has a thickness T_{C} of at least approximately 0.2 T_{L}. FIG. 1 is only a schematic representation and is not drawn to scale.

In an alternate embodiment, the stiff core layer 12 has a thickness at least approximately 50% of the thickness of the laminate 10 and spans substantially the entirety of the laminate 10.

The laminate 10 includes relatively thin outer metal first and second constraining layers 14, 16 flanking the stiff core layer 12; a first damping layer 18 in contact with one of the first and the second constraining layers 14, 16 and spanning substantially the entirety of the respective first or second constraining layer with which it is in contact. The stiff core layer 12 has a thickness at least approximately 10 times the first damping layer 18. Thus if the first damping layer 18 has a thickness T_{D1}, the stiff core layer 12 has a thickness T_{C} of at least approximately 10 T_{D1}.

The laminate 10 may further include a second damping layer 20 in contact with the other of the first and the second constraining layers 14, 16. The first and second damping layers 18, 20 may have a substantially equal thickness. The first damping layer 18 and the second damping layer 20 include a viscoelastic material that provides a measure of damping to the laminate 10 through shear deformation of the viscoelastic material. Preferably, the stiff core layer 12 has a thickness at least approximately 10 times the second damping layer 20. Thus if the second damping layer 20 has a thickness T_{D2}, the stiff core layer 12 has a thickness T_{C} of at least approximately 10 T_{D2}.

In the preferred embodiment, the stiff core layer 12 includes a material having a relatively high stiffness with respect to one or both the first and second damping layers 18, 20. Preferably, the shear modulus of the stiff core layer 12 is at least approximately a factor of 10 higher than the shear modulus of one or both the first and second damping layers 18, 20.

The stiff core layer 12 may be comprised of any suitable material. In the preferred embodiment, the stiff core layer 12 is comprised of a plastic or polymer material such as polypropylene. The first and second constraining layers 14, 16 are preferably a metal such as steel, with a thickness of at least approximately 0.25 mm each. In the preferred embodiment, the stiff core layer 12 has a thickness at least approximately 0.8 mm. The first and second damping layers 18, 20 may have a thickness at least approximately 0.025 mm. In an alternative embodiment, the first and second damping layers 18, 20 may have a thickness at least approximately 0.012 mm.

The materials employed and thicknesses of the stiff core layer 12 and first and second damping layers 18, 20 may be varied for optimal results. Variations in the stiffness and damping properties of the laminate 10 can also be produced by varying the type and thickness of the first and second constraining layers 14, 16 with metals such as steel, aluminum, magnesium or other metals or alloys.

The material for the first damping layer 18 and second damping layer 20 need not be identical, i.e., the first damping layer 18 may include a first viscoelastic material while the second damping layer 20 includes a second viscoelastic material. A technique to broaden the temperature range of optimal damping of the laminate 10 would be to employ a material for the second damping layer 20 which has a different temperature range for optimal damping than the material in the first damping layer 18. Variable results can be produced by optional suppression of the second damping layer 20.

This invention includes a method to increase the structural stiffness and damping of a multilayer laminate 10 having first and second constraining layers 14, 16 including: configuring the first and second constraining layers 14, 16 as a spaced pair of relatively thin outer metal sheets; positioning one relatively thick and lightweight stiff core layer 12 between the pair of relatively thin outer metal sheets and coextensive therewith; and positioning a layer of relatively thin viscoelastic material between one or both of the outer metal sheets and the stiff core layer 12 and coextensive respectively with the one or both of the outer metal sheets.

### Numerical Simulation

A numerical simulation was carried out to compare the performance of the improved multilayer laminate or sandwich structure 10 with other structures at varying thicknesses of the stiff core layer 12, and the first and second damping layers 18, 20. The theoretical simulation is based on the ASTM E756 Oberst beam measurement. The Oberst configuration is used to characterize the damping and stiffness properties of monolithic metals and multilayer structures.

The dynamic stiffness of a monolithic metal or multilayer structure may be expressed in terms of the eigenfrequency of the system. The bending modes of a system illustrate its properties at various eigenfrequencies. Increasing eigenfrequency correlates with greater stiffness. The damping properties of a monolithic metal or multilayer structure may be characterized by the composite loss factor or CLF.

With respect to FIGS. 2 through 10, the simulation compared six different configurations A-F of approximately equal weight as described below. Configuration A is a monolithic steel reference with dimensions 18 mm by 210 mm, with thickness as described below. Configuration B is a three-layer structure with dimensions 18 mm by 210 mm, including one thin viscoelastic damping layer sandwiched between two constraining layers of steel. An example of configuration B is Quiet Steel®, a commercially available material from Material Sciences Corporation of Canton, Mich. Configurations A and B do not have a stiff core layer, while configurations C-F each have a stiff core layer.

Configuration C is a three-layer structure with dimensions 18 mm by 210 mm, including a plastic or polymer stiff core layer sandwiched between two constraining layers of steel having a thickness of 0.25 mm each.

Configurations D, E and F include the five-layer improved multilayer laminate or sandwich structure 10 in accordance with the present invention, with dimensions 18 mm by 210 mm. The laminate 10 includes a first and second constraining layer 14, 16 of steel having a thickness 0.25 mm, and a plastic or polymer stiff core layer 12. The laminate 10 includes a first and second damping layer 18, 20 of viscoelastic material. Configurations D-F are the same except that the first and second damping layers 18, 20 are of thickness 0.025 mm, 0.012 mm and 0.006 mm each in configurations D-F, respectively. Each configuration A-F is labeled accordingly on FIGS. 2-8.

To maintain the iso-weight assumption between configurations A-F, their thicknesses are as follows: for stiff core thicknesses of 0.15, 0.2, 0.4, 0.8, 1.2 and 2.0 mm, A and B have thicknesses of 0.53, 0.53, 0.56, 0.61, 0.66 and 0.76 mm, respectively; and C, D, E and F have thicknesses of 0.65, 0.7, 0.9, 1.30, 1.70 and 2.50 mm, respectively. Configuration B has about the same thickness as A, with the lower density of the thin viscoelastic layer making B marginally lighter than A.

### Graphs for Stiff Core Layer Thickness of 0.8 mm

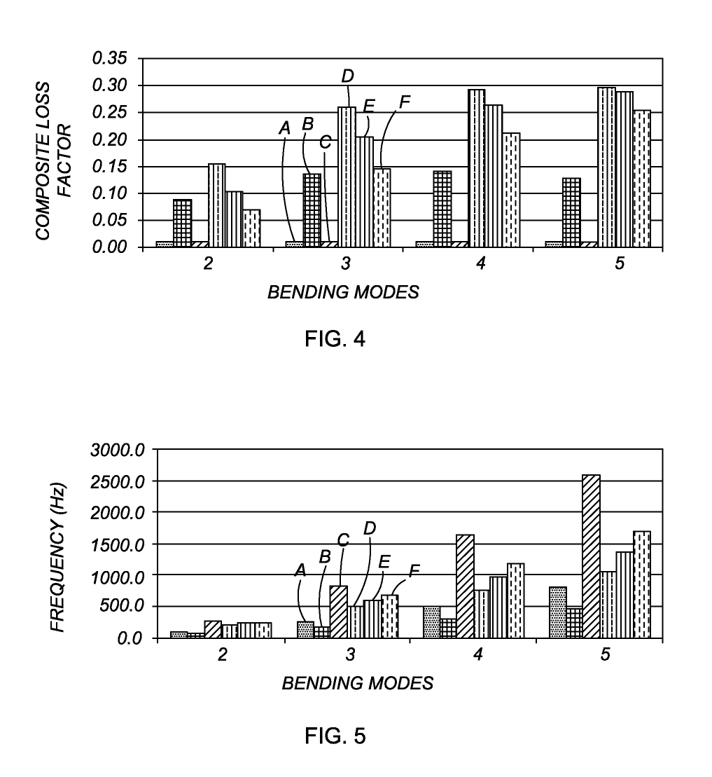

FIGS. 2-4 illustrate results of the simulation for a stiff core thickness of 0.8 mm. FIG. 2 is a graph showing dynamic stiffness characterized by bending eigenfrequencies in Hz at bending modes 2 through 5 for configurations A-F, with plastic or polymer stiff core layer thickness of 0.8 mm for configurations C-F. FIG. 3 is a graph showing dynamic stiffness or bending eigenfrequencies relative to iso-weight monolithic steel at bending modes 2 through 5 for configurations A-F, with plastic or polymer stiff core layer thickness of 0.8 mm for configurations C-F. FIG. 4 is a graph showing composite loss factors at bending modes 2 through 5 for configurations A-F, with plastic or polymer stiff core layer thickness of 0.8 mm for configurations C-F.

### Graphs for Stiff Core Layer Thickness of 2.0 mm

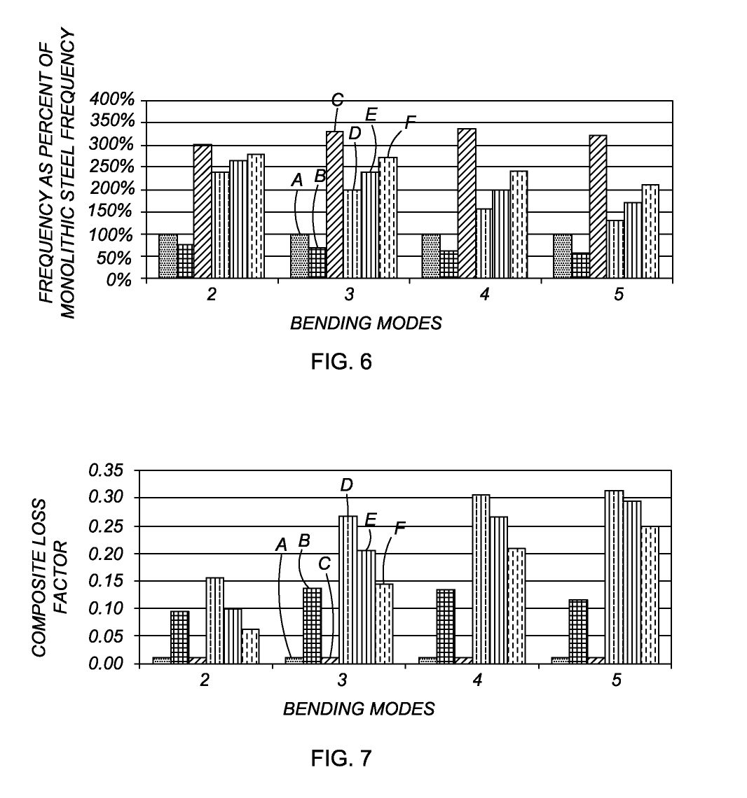

FIGS. 5-7 illustrate results of the simulation for a stiff core thickness of 2.0 mm. FIG. 5 is a graph showing dynamic stiffness characterized by bending eigenfrequencies in Hz at bending modes 2 through 5 for configurations A-F, with a plastic or polymer stiff core layer thickness of 2.0 mm for configurations C-F. FIG. 6 is a graph showing dynamic stiffness or bending eigenfrequencies relative to iso-weight monolithic steel at bending modes 2 through 5 for configurations A-F, with a plastic or polymer stiff core layer thickness of 2.0 mm for configurations C-F. FIG. 7 is a graph showing composite loss factors at bending modes 2 through 5 for configurations A-F, with a plastic or polymer stiff core layer thickness of 2.0 mm for configurations C-F.

### Graphs for Varying Stiff Core and Damping Layer Thicknesses

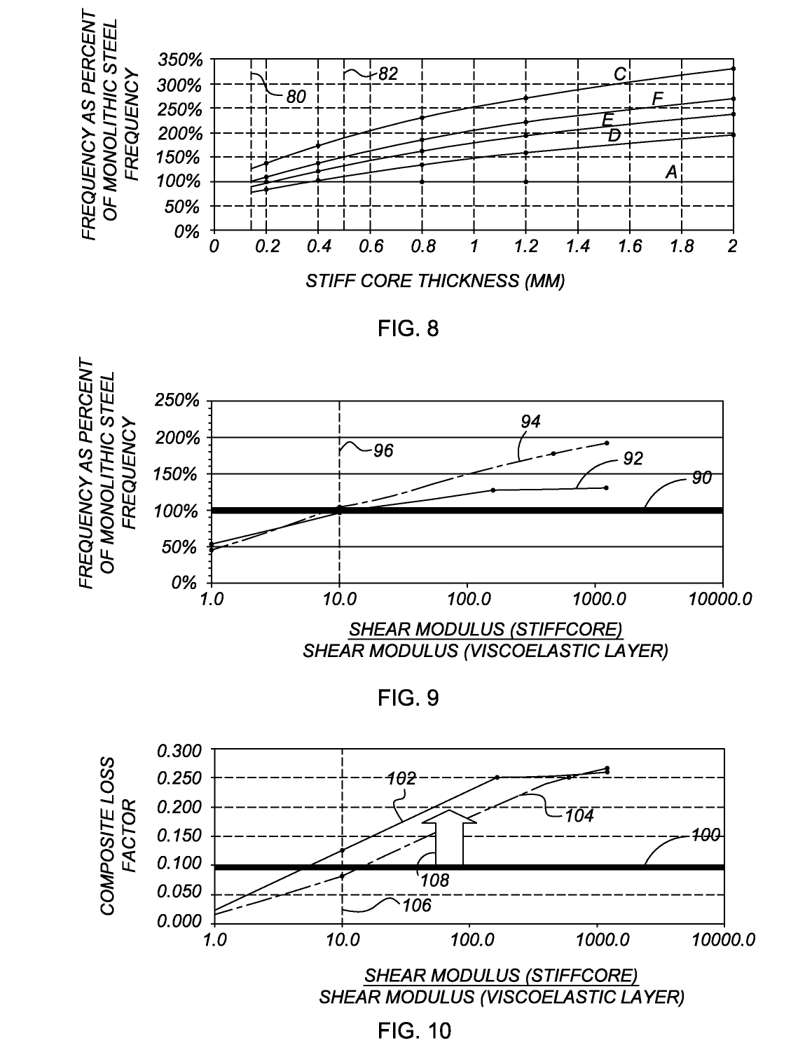

As shown in FIGS. 8-10, dynamic stiffness relative to monolithic steel and composite loss factors (CLF) for bending mode 3 eigenfrequencies are simulated as a function of varying stiff core thicknesses and shear modulus ratios. The bending mode 3 eigenfrequency lies in the 200-500 Hz frequency interval where structure-borne sound problems are often pronounced.

FIG. 8 is a graph showing bending eigenfrequencies relative to iso-weight monolithic steel at bending mode 3 for configurations A and C-F with varying stiff core thicknesses. Line 80 in FIG. 8 indicates where the stiff core layer thickness is equal to 20% of the overall laminate thickness. Line 82 in FIG. 8 indicates where the stiff core layer thickness is equal to 50% of the overall laminate thickness.

FIG. 9 is a graph showing bending eigenfrequencies relative to iso-weight monolithic steel at bending mode 3 for different ratios of the stiff core layer shear modulus to the viscoelastic damping layer shear modulus. Line 90 represents the frequency of monolithic steel. Lines 92, 94 represent graphs for stiff core thicknesses of 0.8 mm and 2.0 mm, respectively.

FIG. 10 is a graph showing composite loss factors or CLF relative to iso-weight monolithic steel at bending mode 3 for different ratios of the stiff core layer shear modulus to the viscoelastic damping layer shear modulus. Line 100 represents a CLF of 0.1. Lines 102, 104 represent graphs for stiff core thicknesses of 0.8 mm and 2.0 mm, respectively. The graphs shown by lines 102, 104 assume a viscoelastic first and second damping layer 18, 20 with a thickness of 0.025 mm, corresponding to configuration D.

### Results of Simulation—Stiffness

As shown in FIGS. 2, 3, 5 and 6, the improved multilayer laminate 10 employed in configurations D-F produces greater stiffness than the monolithic steel reference of the same weight in configuration A. The stiffness is lower than the 3-layer configuration C which does not have a damping component, but higher than the 3-layer configuration B which does have a damping component. The stiffness increase for the same weight is due to the geometrical stackup of the layers for available viscoelastic damping, stiff core and constraining layer materials.

FIG. 8 illustrates that increasing thickness of the stiff plastic core results in greater stiffness compared to the monolithic steel reference, at a constant viscoelastic damping layer thickness. As mentioned above, line 80 in FIG. 8 indicates where the stiff core layer thickness is equal to 20% of the overall laminate thickness. A minimum thickness for the stiff core layer of 20% of the overall laminate thickness is needed to at least meet the stiffness of the monolithic steel reference. Also as shown in FIG. 8, increasing the thickness of the viscoelastic damping layers by going from configuration F at 0.006 mm to configuration D at 0.25 mm would require a greater minimum stiff core thickness to ensure the same level of stiffness.

Thus the minimum recommended thickness of the stiff core layer is at least 20% of the overall laminate thickness and a minimum factor of 10 higher than the viscoelastic damping layers. An alternate recommended thickness of the stiff core layer is at least 50% of the overall laminate thickness. Referring to FIG. 8, line 82 indicates where the stiff core layer thickness is equal to 50% of the overall laminate thickness. For stiff core layer thicknesses much greater than 50% of the overall laminate thickness, the bending stiffness greatly outperforms the iso-weight monolithic steel reference, as shown in FIG. 8.

Referring to FIG. 9, line 96 indicates where the ratio of the stiff core layer shear modulus to the viscoelastic damping layer shear modulus is 10. As seen in FIG. 9, the stiff core layer shear modulus needs to be at least approximately a factor of 10 or higher compared to the viscoelastic damping layer shear modulus to reach at least the stiffness of the monolithic steel reference. A low shear modulus viscoelastic damping layer material would require a greater minimum stiff core thickness to ensure the same level of stiffness.

Referring to FIG. 10, line 106 indicates where the ratio of stiff core shear modulus to viscoelastic damping layer shear modulus is 10. Arrow 108 indicates a CLF higher than 0.1 which is assumed to be “good” damping, with increasing CLF values indicating better damping. As seen in FIG. 10, the stiff core layer shear modulus needs to be at least approximately a factor of 10 or higher compared to the viscoelastic damping layer shear modulus to meet a CLF of 0.1. This factor is higher for a greater stiff core thickness.

Based on the analysis above, the recommended shear modulus of the stiff core layer is at least a factor of 10 or higher than the shear modulus of the viscoelastic damping layer. Note that a viscoelastic damping layer thickness reduction for given material parameters, such as shear modulus and loss factor, is mainly equivalent to the use of a viscoelastic material with higher shear modulus. Reducing the viscoelastic damping layer thickness or alternatively, using a higher shear modulus material in the viscoelastic damping layer, improves the overall stiffness of the laminate and may induce a slight damping penalty.

### Results of Simulation—Damping

As shown in FIGS. 4 and 7, the composite damping loss factor or CLF is higher for configurations D-F for bending modes 3, 4 and 5. For bending mode 2, the CLF for configurations D and E, having viscoelastic thicknesses of 0.025 mm and 0.012 mm, respectively, is higher than configuration B. The CLF is below configuration B in mode 2 only for configuration F, with a viscoelastic thickness of 0.006 mm. The results for the CLF from FIG. 10 are as noted above.

Thus the improved multilayer laminate 10 in the preferred embodiment, as represented by configurations D-F, can significantly outperform an iso-weight monolithic steel reference on both stiffness and damping.

In summary, the main parameters of stiff core layer and viscoelastic damping layer thicknesses and shear modulus ratios were investigated. Increasing stiff core thickness has a very positive effect on stiffness and a slightly positive impact on damping. The viscoelastic damping layer thickness has an opposite effect on stiffness and damping. The simulation results allow the laminate 10 to be tuned to the specific stiffness and damping performance request of the application.

Finally, the calculations presented herein are merely approximations. Varying the parameters of the simulation may produce different results. As previously noted, the viscoelastic material employed in the first and second damping layers 18, 20 need not be identical. The temperature of the simulation was set at 80° F. (27° C.).

While the best modes for carrying out the invention have been described in detail, it is to be understood that the terminology used is intended to be in the nature of words and description rather than of limitation. Those familiar with the art to which this invention relates will recognize that many modifications of the present invention are possible in light of the above teachings. It is, therefore, to be understood that within the scope of the appended claims, the invention may be practiced in a substantially equivalent way other than as specifically described herein.

1. An improved multilayer laminate of increased structural stiffness and damping comprising:
a thick and stiff core layer;
a first and second constraining layer flanking said stiff core layer;
a first damping layer in contact with one of said first and said second constraining layers and spanning substantially the entirety of said first and second constraining layers; and
wherein said stiff core layer has a thickness of at least approximately 10 times said first damping layer.

2. The multilayer laminate of claim 1, wherein said stiff core layer has a thickness of at least approximately 20% of said multilayer laminate.

3. The multilayer laminate of claim 1, wherein said stiff core layer has a thickness of at least approximately 50% of said multilayer laminate.

4. The multilayer laminate of claim 1, wherein said stiff core layer comprises a material having a relatively high stiffness with respect to said first damping layer.

5. The multilayer laminate of claim 1, wherein the shear modulus of said stiff core layer is at least approximately a factor of 10 higher than the shear modulus of said first damping layer.

6. The multilayer laminate of claim 1, wherein said stiff core layer is comprised of a polymer material.

7. The multilayer laminate of claim 1, wherein said first and second constraining layers are metal; and
wherein said first and second constraining layers each have a thickness at least approximately 0.25 mm.

8. The multilayer laminate of claim 1, wherein said stiff core layer is comprised of polypropylene;
wherein said stiff core layer has a thickness at least approximately 0.8 mm; and
wherein said first damping layer has a thickness at least approximately 0.025 mm.

9. The multilayer laminate of claim 1, wherein said first damping layer comprises a first viscoelastic material.

10. The multilayer laminate of claim 1, further including a second damping layer in contact with the other of said first and said second constraining layers.

11. The multilayer laminate of claim 10, wherein said stiff core layer comprises a material having a relatively high stiffness with respect to said second damping layer; and
wherein said stiff core layer has a thickness at least approximately 10 times said second damping layer.

12. The multilayer laminate of claim 10, wherein said first and second damping layers have a substantially equal thickness.

13. The multilayer laminate of claim 10, wherein the shear modulus of said stiff core layer is at least approximately a factor of 10 higher than the shear modulus of said second damping layer.

14. The multilayer laminate of claim 10, wherein said first damping layer comprises a first viscoelastic material, and said second damping layer comprises a second viscoelastic material.

15. The multilayer laminate of claim 14, wherein said first viscoelastic material and said second viscoelastic material have differing temperature ranges for optimal damping.

16. A high-stiffness vibration damping structure comprising:
a stiff core layer that has a thickness of at least 20% of said structure and spans substantially the entirety of said structure;
a first and second constraining layer flanking said core layer;
a first damping layer adjacent one of said first and said second constraining layers;
wherein said stiff core layer has a thickness at least 10 times said first damping layer; and
wherein the shear modulus of said stiff core layer is at least a factor of 10 higher than said first damping layer.

17. The high-stiffness vibration damping structure of claim 16,
wherein said stiff core layer is comprised of polypropylene;
wherein said first and second constraining layers are metal;
wherein said first and second constraining layers each have a thickness of at least 0.25 mm;
wherein said stiff core layer has a thickness of at least 0.8 mm; and
wherein said first damping layer has a thickness of at least 0.012 mm.

18. The high-stiffness vibration damping structure of claim 16,
wherein said stiff core layer is comprised of polypropylene;
wherein said first and second constraining layers are metal;
wherein said first and second constraining layers each have a thickness of at least 0.25 mm;
wherein said stiff core layer has a thickness of at least 0.8 mm; and
wherein said first damping layer has a thickness of at least 0.025 mm.

19. The high-stiffness vibration damping structure of claim 16, further including a second damping layer in contact with the other of said first and said second constraining layers.

20. The high-stiffness vibration damping structure of claim 17, further including a second damping layer in contact with the other of said first and said second constraining layers.

21. The high-stiffness vibration damping structure of claim 18, further including a second damping layer in contact with the other of said first and said second constraining layers.

22. A method to increase the structural stiffness and damping of a multilayer laminate having first and second constraining layers comprising:
configuring said first and second constraining layers as a spaced pair of relatively thin outer metal sheets;
positioning one relatively thick and lightweight stiff core between said pair of relatively thin outer metal sheets and coextensive therewith; and
positioning a layer of relatively thin viscoelastic material between one or both of said outer metal sheets and said stiff core and coextensive respectively with said one or both of said outer metal sheets.
